(19) United States
(12) Patent Application Publication
(10) Pub. No.: US 2026/0258234 A1
(43) Pub. Date: Sep. 3, 2026

(54) RUBBER COMPOSITION BASED ON A HIGHLY SATURATED ELASTOMER AND A LIQUID PLASTICIZER

(71) Applicant: COMPAGNIE GENERALE DES ETABLISSEMENTS MICHELIN, Clermont-Ferrand (FR)

(72) Inventors: JOSE-CARLOS ARAUJO DA SILVA, Clermont-Ferrand (FR); THOMAS FERRAND, Clermont-Ferrand (FR); MAXIME PRAS, Clermont-Ferrand (FR)

(21) Appl. No.: 18/866,379

(22) PCT Filed: May 16, 2023
(86) PCT No.: PCT/EP2023/063131

§ 371 Date: Nov. 15, 2024

(30) Foreign Application Priority Data
May 17, 2022 (FR) FR2204646

(51) Int. Cl. C08L 23/0807; C08K 3/04; C08K 3/06; C08K 3/22; C08K 3/36; C08K 5/103; C08K 5/31; C08K 5/44

(52) U.S. Cl. CPC C08L 23/083; C08K 3/04; C08K 3/06; C08K 3/22; C08K 3/36; C08K 5/103; C08K 5/31; C08K 5/44; C08K 2003/2296

(57) ABSTRACT

Rubber compositions having improved rolling resistance and wet grip are based on at least one elastomer matrix comprising at least one copolymer containing ethylene units and 1,3-diene units, the molar fraction of ethylene units in the copolymer being within a range extending from more than 50% to 95%, the copolymer not containing any unit of a 1,3-diene of formula CH₂═CR—CH═CH₂, the symbol R representing a hydrocarbon chain having 3 to 20 carbon atoms; a liquid plasticizer comprising from 45% to 100% by weight of unsaturated fatty acid triester of glycerol; more than 30 phr of reinforcing filler; and a crosslinking system. Rubber articles, in particular pneumatic or non-pneumatic tires, may comprise the rubber compositions, especially in the tread of such tires.

The field of the present invention is that of rubber compositions comprising a highly saturated diene elastomer, in particular compositions which are intended to be used in a tyre.

A tyre has to meet, in a known manner, a large number of often conflicting technical requirements, including low rolling resistance, high wear resistance, and also high dry grip and high wet grip.

Among these properties, the rolling resistance and the wear resistance prove to be the most important from the environmental viewpoint as they make it possible, respectively, to reduce fuel consumption and to extend the service life of the tyres.

The diene rubber compositions customarily used in tyres are rubber compositions reinforced with highly unsaturated diene elastomers such as polybutadienes, polyisoprenes, and copolymers of butadiene and styrene. It has been proposed, notably in WO 2014/114607 A1, to use copolymers of ethylene and of 1,3-butadiene in rubber compositions for tyres. Reinforced rubber compositions of ethylene/1,3-butadiene copolymer are notably described for improving the compromise between the performance properties of a tyre, namely the wear resistance and the rolling resistance.

However, it still remains advantageous for tyre manufacturers to improve the overall compromise in performance properties, taking into account in particular the wet grip. However, it is known that the rolling resistance and the wet grip are performance properties that are very often contradictory. There is therefore a real need to have a solution for improving the compromise in performance properties between rolling resistance and wet grip.

On continuing its research studies, the Applicant has discovered, unexpectedly, that the use of a specific liquid plasticizer, combined with a highly saturated copolymer containing ethylene units and 1,3-diene units, makes it possible to simultaneously improve the rolling resistance and the wet grip.

Thus, a first subject of the invention is a rubber composition based on at least:
an elastomer matrix comprising at least one copolymer containing ethylene units and 1,3-diene units, the molar fraction of ethylene units in the copolymer being within a range extending from more than 50% to 95%, the copolymer not containing any unit of a 1,3-diene of formula CH₂═CR—CH═CH₂, the symbol R representing a hydrocarbon chain having 3 to 20 carbon atoms,
a liquid plasticizer comprising from 45% to 100% by weight of unsaturated fatty acid triester of glycerol,
more than 30 phr of reinforcing filler,
a crosslinking system.

Another subject of the invention is a rubber article comprising a composition according to the invention, in particular a pneumatic or non-pneumatic tyre, the tread of which comprises a composition according to the invention.

### I—DEFINITIONS

The expression “based on” used to define the constituents of a catalytic system means the mixture of these constituents, or the product of the reaction of a portion or all of these constituents with each other.

The expression “composition based on” should be understood to mean a composition including the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

The term “elastomer matrix” means all of the elastomers of the composition, including the copolymer defined below.

Unless otherwise indicated, the contents of the units resulting from the insertion of a monomer into a copolymer are expressed as molar percentage relative to all of the monomer units of the copolymer.

For the purposes of the present invention, the expression “part by weight per hundred parts by weight of elastomer” (or phr) should be understood as meaning the part by weight per hundred parts by mass of the elastomer matrix.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

The compounds mentioned in the description may be of fossil origin or be biobased. In the latter case, they may be partially or completely derived from biomass or obtained from renewable raw materials derived from biomass. In the same way, the compounds mentioned can also originate from the recycling of pre-used materials, that is to say that they can, partially or completely, result from a recycling process, or else be obtained from starting materials which themselves result from a recycling process.

Unless otherwise indicated, all the glass transition temperature “Tg” values described herein are measured in a known manner by DSC (Differential Scanning calorimetry) according to the standard ASTM D3418 (1999).

### II—DESCRIPTION OF THE INVENTION

### II-1 Elastomer Matrix

According to the invention, the elastomer matrix comprises at least one copolymer containing ethylene units and 1,3-diene units, the ethylene units in the copolymer representing between 50 mol % and 95 mol % of the monomer units of the copolymer, the copolymer not containing any unit of a 1,3-diene of formula CH₂═CR—CH═CH₂, the symbol R representing a hydrocarbon chain having 3 to 20 carbon atoms (hereinafter referred to as “the copolymer”).

The expression “copolymer containing ethylene units and 1,3-diene units” is understood to mean any copolymer comprising, within its structure, at least ethylene units and 1,3-diene units. The copolymer can thus comprise monomer units other than ethylene units and 1,3-diene units. For example, the copolymer may also comprise α-olefin units, notably α-olefin units having from 3 to 18 carbon atoms, advantageously having 3 to 6 carbon atoms. For example, the α-olefin units may be chosen from the group consisting of propylene, butene, pentene, hexene or mixtures thereof. However, the copolymer does not comprise any unit of a 1,3-diene of formula CH₂═CR—CH═CH₂, the symbol R representing a hydrocarbon chain having 3 to 20 carbon atoms.

In a known manner, the expression “ethylene unit” refers to the —(CH₂—CH₂)-unit resulting from the insertion of ethylene into the elastomer chain.

In a known manner, the expression “1,3-diene unit” refers to units resulting from the insertion of the 1,3-diene via a 1,4 addition, a 1,2 addition or a 3,4 addition in the case of a substituted diene such as isoprene for example.

Preferably, the 1,3-diene units are selected from the group consisting of butadiene units, isoprene units and mixtures of these 1,3-diene units. In particular, the 1,3-diene units of the copolymer may be 1,3-diene units having 4 to 12 carbon atoms, for example 1,3-butadiene or 2-methyl-1,3-butadiene (or isoprene) units. More preferably, the 1,3-diene units are predominantly, in moles, or even preferentially exclusively, 1,3-butadiene units.

In the copolymer, the ethylene units represent between 50 mol % and 95 mol % of the monomer units of the copolymer. Advantageously, the ethylene units in the copolymer represent between 55 mol % and 90 mol %, preferably from 60 mol % to 90 mol %, preferably from 70 mol % to 85 mol %, of the monomer units of the copolymer.

Advantageously, the copolymer is a copolymer of ethylene and of a 1,3-diene (preferably 1,3-butadiene), that is to say, according to the invention, a copolymer consisting exclusively of ethylene units and of 1,3-diene (preferably 1,3-butadiene) units. Of course, in accordance with the invention, the 1,3-diene has a formula other than CH₂═CR—CH═CH₂, the symbol R representing a hydrocarbon chain having 3 to 20 carbon atoms.

When the copolymer is a copolymer of ethylene and a 1,3-diene, said copolymer advantageously contains units of formula (I) and/or (II). The presence of a saturated 6-membered ring unit, 1,2-cyclohexanediyl, of formula (I) as a monomer unit in the copolymer may result from a series of very specific insertions of ethylene and of 1,3-butadiene into the polymer chain during its growth.

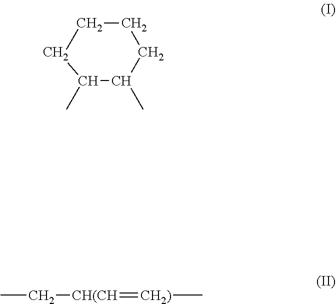

For example, the copolymer of ethylene and of a 1,3-diene may be free of units of formula (I). In this case, it preferably contains units of formula (II).

When the copolymer of ethylene and a 1,3-diene comprises units of formula (I) or units of formula (II) or else units of formula (I) and units of formula (II), the molar percentages of the units of formula (I) and of the units of formula (II) in the copolymer, respectively o and p, preferably satisfy the following equation (eq. 1), more preferentially satisfy the equation (eq. 2), o and p being calculated on the basis of all the monomer units of the copolymer.

$$0 < o + p \leq 25 \qquad ( eq . 1 )$$

$$0 < o + p < 20 \qquad ( eq . 2 )$$

According to the invention, the copolymer, preferably the copolymer of ethylene and a 1,3-diene (preferably 1,3-butadiene), is a random copolymer.

Advantageously, the number-average mass (Mn) of the copolymer, preferably of the copolymer of ethylene and of a 1,3-diene (preferably of 1,3-butadiene), is in a range from 100 000 to 300 000 g/mol, preferably from 150 000 to 250 000 g/mol.

The Mn of the copolymer is determined in a known manner by size exclusion chromatography (SEC) as described in point III-1.2 below.

The copolymer may be obtained according to various synthetic methods known to those skilled in the art, notably as a function of the targeted microstructure of the copolymer. Generally, it may be prepared by copolymerization at least of a diene, preferably a 1,3-diene, more preferably 1,3-butadiene, and of ethylene and according to known synthetic methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the applicant. The copolymer, including the case when it is random, may also be prepared via a process using a catalytic system of preformed type such as those described in WO 2017/093654 A1, WO 2018/020122 A1 and WO 2018/020123 A1.

The copolymer may consist of a mixture of copolymers containing ethylene units and 1,3-diene units which differ from each other by virtue of their microstructures and/or their macrostructures.

According to the invention, the elastomer matrix may comprise at least one other diene elastomer, which is not the copolymer as defined above, but this is not necessary. Thus, preferentially, the content of the at least one copolymer is within a range extending from 30 to 100 phr, preferably from 50 to 100 phr, more preferably from 80 to 100 phr.

Advantageously, the at least one copolymer containing ethylene units and 1,3-diene units is the only elastomer of the composition, that is to say that it represents 100% by weight of the elastomer matrix.

The term “diene” elastomer (or, without distinction, rubber), whether natural or synthetic, should be understood, in a known way, as meaning an elastomer consisting, at least in part (i.e., a homopolymer or a copolymer), of diene monomer units (monomers bearing two conjugated or non-conjugated carbon-carbon double bonds). This definition includes the copolymer containing ethylene units and 1,3-diene units.

When the elastomer matrix comprises at least one other diene elastomer which is not the copolymer containing ethylene units and 1,3-diene units, the at least one other elastomer may be, for example, selected from the group consisting of polybutadienes (BRs), natural rubber (NR), synthetic polyisoprenes (IRs), butadiene copolymers, isoprene copolymers, and mixtures of these elastomers. The butadiene copolymers are particularly selected from the group consisting of butadiene/styrene copolymers (SBRs).

### II-2 Plasticizing System

The rubber composition according to the invention is based on at least one liquid plasticizer comprising from 45% to 100% by weight of unsaturated fatty acid triester of glycerol. By definition, a liquid plasticizer is liquid at ambient temperature (20° C., 1 atm).

Advantageously, the fatty acid of the unsaturated fatty acid triester of glycerol comprises from 60% to 100% by weight, more preferably from 70% to 100% by weight, of unsaturated fatty acid triester of glycerol. Particularly advantageously, the unsaturated fatty acid of the unsaturated fatty acid triester is an unsaturated C₁₂-C₂₂ fatty acid (i.e., comprising from 12 to 22 carbon atoms).

Triester and fatty acid are understood to also mean a mixture of triesters or a mixture of fatty acids, respectively. The fatty acid of the unsaturated fatty acid triester of glycerol preferably comprises more than 60% by weight, more preferentially more than 70% by weight, of an unsaturated C₁₈ fatty acid, that is to say selected from the group consisting of oleic acid, linoleic acid, linolenic acid and mixtures thereof. More preferentially, whether it is of synthetic or natural origin, the fatty acid used comprises more than 60% by weight, even more preferentially more than 70% by weight, of oleic acid.

Thus, advantageously, the fatty acid of the unsaturated fatty acid triester of glycerol comprises more than 60% by weight, preferably more than 70% by weight, of a fatty acid selected from the group consisting of oleic acid, linoleic acid, linolenic acid and mixtures thereof, and even more advantageously more than 60% by weight, preferably more than 70% of oleic acid. Such triesters with a high content of oleic acid are well known; they have been described, for example, in patent application WO 02/088238 as plasticizers in tyre treads.

Particularly advantageously, the unsaturated fatty acid triester of glycerol is glycerol trioleate.

Preferably, the unsaturated fatty acid triester of glycerol is a vegetable oil, preferably a vegetable oil selected from the group consisting of sunflower oil, rapeseed oil and mixtures thereof.

The Tg of the liquid plasticizer comprising from 45% to 100% by weight of unsaturated fatty acid triester of glycerol is advantageously below −70° C., preferably within a range extending from −100° C. to less than −70° C., preferably from −90° C. to −75° C.

The content of the liquid plasticizer comprising from 45% to 100% by weight of unsaturated fatty acid triester of glycerol may be within a range extending from 5 to 50 phr, preferably from 6 to 40 phr, more preferably from 8 to 30 phr.

According to the invention, the composition may comprise a liquid plasticizer other than the liquid plasticizer comprising from 45% to 100% by weight of unsaturated fatty acid triester of glycerol, but this is neither mandatory nor preferred.

When the composition comprises another liquid plasticizer, the total content of liquid plasticizer is preferably within a range extending from 5 to 150 phr, preferably from 10 to 100 phr.

Preferably, the composition does not comprise any liquid plasticizer other than the liquid plasticizer comprising from 45% to 100% by weight of unsaturated fatty acid triester of glycerol or comprises less than 20 phr, preferably less than 10 phr, preferably less than 5 phr, thereof. More preferably, the composition does not comprise any liquid plasticizer other than the liquid plasticizer comprising from 45% to 100% by weight of unsaturated fatty acid triester of glycerol.

The composition according to the invention may comprise a plasticizing hydrocarbon resin, the Tg of which is above 20° C., which is, by definition, a solid at ambient temperature and pressure (20° C., 1 atm).

Plasticizing hydrocarbon resins are polymers that are well known to those skilled in the art, essentially based on carbon and hydrogen but which may include other types of atoms, for example oxygen, and can be used in particular as plasticizers or tackifiers in polymer matrices. They are by nature at least partially miscible (i.e. compatible) at the contents used with the compositions of the polymers for which they are intended, so as to act as true diluents. They have been described, for example, in the book entitled “Hydrocarbon Resins” by R. Mildenberg, M. Zander and G. Collin (New York, V C H, 1997, ISBN 3-527-28617-9), Chapter 5 of which is devoted to their applications, notably in the tyre rubber engineering field (5.5. “Rubber Tires and Mechanical Goods”). In a known manner, these hydrocarbon resins can also be described as thermoplastic resins in the sense that they soften when heated and can thus be moulded.

The softening point of the plasticizing hydrocarbon resins is measured according to standard ISO 4625 (“Ring and Ball” method). The Tg is measured according to the standard ASTM D3418 (1999). The macrostructure (Mw, Mn and PDI) of the plasticizing hydrocarbon resin is determined by size exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

The plasticizing hydrocarbon resins may be aliphatic or aromatic or else of the aliphatic/aromatic type, that is to say based on aliphatic and/or aromatic monomers. They may be natural or synthetic and may or may not be petroleum-based (if such is the case, they are also known as petroleum resins).

Aromatic monomers that are suitable include, for example: styrene, α-methylstyrene, indene, ortho-, meta- or para-methylstyrene, vinyltoluene, para-(tert-butyl) styrene, methoxystyrenes, chlorostyrenes, vinylmesitylene, divinylbenzene, vinylnaphthalene or any vinylaromatic monomer derived from a C₉ fraction (or more generally from a C₈ to C₁₀ fraction). Preferably, the vinylaromatic monomer is styrene or a vinylaromatic monomer derived from a C₉ fraction (or more generally from a C₈ to C₁₀ fraction). Preferably, the vinylaromatic monomer is the minor monomer, expressed as a mole fraction, in the copolymer under consideration.

Preferably, the plasticizing hydrocarbon resin is selected from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and mixtures thereof, preferably from terpene copolymer resins, C₅ fraction copolymer resins, C₉ fraction copolymer resins, and mixtures thereof.

Preferably, the plasticizing hydrocarbon resin has at least any one of the following characteristics:
a Tg above 30° C.;
a number-average molecular mass (Mn) of between 300 and 2000 g/mol, more preferentially between 400 and 1500 g/mol;
a polydispersity index (PDI) of less than 3, more preferentially of less than 2 (as a reminder: PDI=Mw/Mn with Mw being the weight-average molecular mass).

More preferably, this plasticizing hydrocarbon resin exhibits all of the preferred characteristics above.

The preferred plasticizing hydrocarbon resins above are well known to those skilled in the art and are commercially available, for example the polylimonene resins sold by DRT under the name Dercolyte L120 (Mn=625 g/mol; Mw=1010 g/mol; PDI=1.6; Tg=72° C.), or by Arizona under the name Sylvagum TR7125C (Mn=630 g/mol; Mw=950 g/mol; PDI=1.5; Tg=70° C.); C5 fraction/vinylaromatic, notably C5 fraction/styrene or C5 fraction/C9 fraction copolymer resins sold by Neville Chemical Company under the names Super Nevtac 78, Super Nevtac 85 or Super Nevtac 99, by Goodyear Chemicals under the name Wingtack Extra, by Kolon under the names Hikorez T1095 and Hikorez T1100, or by Exxon under the names Escorez 2101 and Escorez 1273; and the limonene/styrene copolymer resins sold by DRT under the name Dercolyte TS 105, or by Arizona Chemical Company under the names ZT115LT and ZT5100.

When it is included in the composition, the content of plasticizing hydrocarbon resin with a Tg above 20° C. is within the range extending from 2 to 200 phr, preferably from 2 to 100 phr, preferably from 5 to 70 phr, preferably from 10 to 50 phr.

### II-3 Reinforcing Filler

The composition according to the invention is based on at least 30 phr of reinforcing filler. A reinforcing filler typically consists of nanoparticles having an average (weight-average) particle size of less than a micrometre, generally less than 500 nm, usually between 20 and 200 nm, in particular and more preferentially between 20 and 150 nm.

The reinforcing filler can comprise carbon black, silica or a mixture thereof. Advantageously, the reinforcing filler of the composition according to the invention comprises more than 50% by weight, preferably more than 80% by weight, of silica.

The content of reinforcing filler is adjusted by those skilled in the art according to the use of the rubber composition. Advantageously, the content of reinforcing filler in the composition according to the invention is within a range extending from 35 to 200 phr, preferably from 40 to 180 phr, preferably from 50 to 160 phr.

All carbon blacks, in particular the blacks conventionally used in tyres or their treads, are suitable as carbon blacks. Among said carbon blacks, mention will more particularly be made of the reinforcing carbon blacks of the 100, 200 and 300 series, or the blacks of the 500, 600 or 700 series (ASTM D-1765-2017 grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used. The carbon blacks might, for example, be already incorporated into the diene elastomer, notably an isoprene elastomer, in the form of a masterbatch (see, for example, patent applications WO 97/36724-A2 and WO 99/16600-A1).

Any type of precipitated silica, notably highly dispersible silicas (HDS), is suitable for use. These precipitated silicas, which may or may not be highly dispersible, are well known to a person skilled in the art. Mention may be made, for example, of the silicas described in applications WO 03/016215-A1 and WO 03/016387-A1. Among the commercial HDS silicas, use may notably be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

In order to couple the silica to the diene elastomer, use is advantageously made, in a well-known way, of an at least bifunctional coupling agent (or bonding agent) intended to provide a satisfactory connection, of chemical and/or physical nature, between the inorganic filler (surface of its particles) and the diene elastomer. Thus, when the reinforcing filler comprises silica, the composition additionally comprises at least one agent for coupling silica to a diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (which may be symmetrical or asymmetrical) such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl)propyl) octanethioate sold by Momentive under the name NXT Silane. More preferentially, the organosilane is an organosilane polysulfide.

When silica is used, the content of coupling agent in the composition of the invention can be readily adjusted by a person skilled in the art. Typically, the content of coupling agent represents from 0.5% to 15% by weight relative to the amount of silica.

### II-4 Crosslinking System

The crosslinking system may be any type of system known to those skilled in the art in the field of rubber compositions for tyres. It can in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present. In addition, use may advantageously be made of various known vulcanization activators, such as zinc oxide, stearic acid or equivalent compound, such as stearic acid salts, and salts of transition metals, guanidine derivatives (in particular diphenylguanidine), or also known vulcanization retarders.

The sulfur is used in a preferential content of between 0.3 phr and 10 phr, more preferentially between 0.3 and 5 phr. The primary vulcanization accelerator is used at a preferential content of between 0.5 and 10 phr, more preferentially of between 0.5 and 5 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### II-5 Possible Additives

The rubber compositions according to the invention may optionally also comprise all or some of the usual additives normally used in elastomer compositions for tyres: pigments, protective agents such as anti-ozone waxes, chemical anti-ozonants, antioxidants, anti-fatigue agents, etc.

### II-6 Preparation of the Rubber Compositions

The compositions that may be used in the context of the present invention may be manufactured in appropriate mixers using two successive preparation phases that are well known to those skilled in the art:
a first phase of thermomechanical working or kneading (“non-productive” phase), that can be performed in a single thermomechanical step during which all the necessary constituents, notably the elastomeric matrix, the reinforcing filler and the optional various other additives, with the exception of the crosslinking system, are introduced into an appropriate mixer, such as a standard internal mixer (for example of Banbury type). The incorporation of the optional filler into the elastomer may be performed in one or more portions while thermomechanically kneading. If the filler is already incorporated, totally or partially, in the elastomer in the form of a masterbatch, as is described, for example, in the applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated. The non-productive phase can be carried out at high temperature, up to a maximum temperature of between 110° C. and 200° C., preferably between 130° C. and 185° C., for a period of time generally of between 2 and 10 minutes;
a second phase of mechanical working (“productive” phase), which is performed in an external mixer, such as an open mill, after cooling the mixture obtained during the non-productive first phase down to a lower temperature, typically below 120° C., for example between 40° C. and 100° C. The crosslinking system is then incorporated and the combined mixture is then mixed for a few minutes, for example between 5 and 15 min.

Such phases have been described, for example, in Applications EP-A-0 501 227, EP-A-0 735 088, EP-A-0 810 258, WO 00/05300 or WO 00/05301.

The final composition thus obtained is then calendered, for example in the form of a sheet or of a slab, notably for laboratory characterization, or else is extruded (or co-extruded with another rubber composition) in the form of a rubber semi-finished product (or profiled element) which can be used, for example, as a tyre tread. These products may then be used for the manufacture of tyres, according to the techniques known to those skilled in the art.

The composition may be either in the uncured state (before crosslinking or vulcanization) or in the cured state (after crosslinking or vulcanization), or may be a semi-finished product which can be used in a tyre.

The composition may be crosslinked in a manner known to those skilled in the art, for example at a temperature of between 130° C. and 200° C., under pressure.

### II-7 Rubber Article

The present invention also relates to a rubber article comprising at least one composition according to the invention. Preferably, the rubber article is selected from the group consisting of pneumatic or non-pneumatic tyres.

More particularly, the invention also relates to a pneumatic or non-pneumatic tyre provided with a tread comprising a composition according to the invention. The composition according to the invention may constitute part or all of the tyre tread.

The tyre according to the invention may be intended to equip any type of vehicle, in particular motor vehicles, without any particular limitation.

### III—EXAMPLES

### III-1 Measurements and Tests Used

### III-1.1 Determination of the Microstructure of the Elastomers:

The microstructure of the ethylene-butadiene copolymers is determined by ¹H NMR analysis, assisted by ¹³C NMR analysis when the resolution of the ¹H NMR spectra does not make it possible to assign and quantify all the species. The measurements are carried out using a Bruker 500 MHz NMR spectrometer at frequencies of 500.43 MHz for observing protons and 125.83 MHz for observing carbons. For the elastomers that are insoluble but have the ability to swell in a solvent, a 4 mm z-grad HRMAS probe is used for proton and carbon observation in proton-decoupled mode. The spectra are acquired at spinning speeds of from 4000 Hz to 5000 Hz. For the measurements on soluble elastomers, a liquid NMR probe is used for proton and carbon observation in proton-decoupled mode. The insoluble samples are prepared in rotors filled with the material analysed and a deuterated solvent which makes swelling possible, in general deuterated chloroform (CDCl₃). The solvent used must always be deuterated and its chemical nature may be adapted by a person skilled in the art. The amounts of material used are adjusted so as to obtain spectra of sufficient sensitivity and resolution. The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by a person skilled in the art. In both cases (soluble sample or swollen sample): A 30° single pulse sequence is used for proton NMR. The spectral window is adjusted to observe all the resonance lines belonging to the molecules analysed. The number of accumulations is set so as to obtain a signal-to-noise ratio that is sufficient for quantification of each unit. The recycle delay between each pulse is adapted to obtain a quantitative measurement. For the carbon NMR, a single 30° pulse sequence is used with proton decoupling only during acquisition to avoid the “nuclear Overhauser” effects (NOE) and to remain quantitative. The spectral window is adjusted to observe all the resonance lines belonging to the molecules analysed. The number of accumulations is set so as to obtain a signal-to-noise ratio that is sufficient for quantification of each unit. The recycle delay between each pulse is adapted to obtain a quantitative measurement. The NMR measurements are performed at 25° C.

### III-1.2 Determination of the Macrostructure of the Polymers by Size Exclusion Chromatography (SEC):

### a) Principle of the Measurement:

Size exclusion chromatography or SEC makes it possible to separate macromolecules in solution according to their size by passage through columns packed with a porous gel. The macromolecules are separated according to their hydrodynamic volume, the bulkiest being eluted first.

Combined with three detectors (3D), a refractometer, a viscometer and a 90° light-scattering detector, SEC makes it possible to comprehend the distribution of the absolute molar masses of a polymer. The various number-average (Mn) and weight-average (Mw) absolute molar masses and the polydispersity index (PDI=Mw/Mn) can also be calculated.

### b) Preparation of the Polymer:

Each sample is dissolved in tetrahydrofuran at a concentration of about 1 g/1. The solution is then filtered through a filter with a porosity of 0.45 μm before injection.

### c) 3D SEC Analysis:

In order to determine the number-average molar mass (Mn), and where appropriate the weight-average molar mass (Mw) and the polydispersity index (PDI), of the polymers, the method below is used.

The number-average molar mass (Mn), the weight-average molar mass (Mw) and the polydispersity index of the polymer (hereinafter sample) are determined in an absolute way by triple detection size exclusion chromatography (SEC). Triple detection size exclusion chromatography has the advantage of measuring average molar masses directly without calibration.

The value of the refractive index increment dn/dc of the solution of the sample is measured on-line using the area of the peak detected by the refractometer (RI) of the liquid chromatography equipment. To apply this method, it must be verified that 100% of the sample mass is injected and eluted through the column. The area of the RI peak depends on the concentration of the sample, on the constant of the RI detector and on the value of the dn/dc.

In order to determine the average molar masses, use is made of the 1 g/l solution previously prepared and filtered, which is injected into the chromatographic system. The apparatus used is a Waters Alliance chromatographic line. The elution solvent is tetrahydrofuran containing 250 ppm of BHT (2,6-di(tert-butyl)-4-hydroxytoluene), the flow rate is 1 ml·min⁻¹, the temperature of the system is 35° C. and the analysis time is 60 min. The columns used are a set of three Agilent columns of PL Gel Mixed B LS trade name. The volume of the sample solution injected is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.

For the calculation of the number-average molar masses and the polydispersity index, the value of the refractive index increment dn/dc of the solution of the sample obtained above is integrated. The software for processing the chromatographic data is the Astra system from Wyatt.

### III-1.3 Determination of the Mooney Viscosity

For the polymers and rubber compositions, the Mooney viscosities ML (1+4) at 100° C. are measured using an oscillating consistometer according to the standard ASTM D-1646 (1999). The Mooney plasticity measurement is carried out according to the following principle: the composition in the uncured state (i.e., before curing) is moulded in a cylindrical chamber heated to 100° C. After preheating for one minute, the rotor rotates within the test specimen at 2 rpm and the working torque for maintaining this movement after rotating for 4 minutes is measured. The Mooney plasticity ML (1+4) is expressed in “Mooney unit” (MU, with 1 MU=0.83 N·m).

### III-1.4 Dynamic Properties

The dynamic properties tan(δ) max are measured at a temperature of 23° C. on a viscosity analyzer (Metravib VA4000) according to standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under defined temperature conditions, for example at 23° C., according to the standard ASTM D 1349-99, is recorded. A strain amplitude sweep is performed from 0.1% to 50% (outward cycle) and then from 50% to 0.1% (return cycle). The results made use of are the loss factor tan(δ) and For the return cycle, the maximum value of tan(δ) observed, denoted tan(δ) max at 23° C., is indicated.

It is recalled that, as is well known to those skilled in the art, the tan(δ) max value at 23° C. is representative of the hysteresis. The tan(δ) max at 23° C. performance results are expressed in base 100, the value 100 being assigned to the control. A result of greater than 100 indicates that the composition of the example under consideration has a lower hysteresis at 23° C., reflecting a lower rolling resistance of the tread comprising such a composition.

Moreover, the integral property of the tan(δ) value observed from −30° C. to 0° C. (Int. tan(δ) [−30° C.; 0° C.]) was also measured on a viscosity analyzer (Metravib VA4000) according to the standard ASTM D5992-96. The response of a sample of crosslinked composition (cylindrical specimen with a thickness of 4 mm and a cross-section of 400 m²), subjected to a simple alternating sinusoidal shear stress, at a frequency of 10 Hz, during a temperature sweep, under a stationary stress of 0.7 MPa, was recorded.

It will be recalled that, as is well known to those skilled in the art, the integral of the tan(δ) value observed from −30° C. to 0° C. is representative of the wet grip. The Int. tan(δ) [−30° C.; 0° C.] performance results are expressed in base 100, with 100 being assigned to the control. A result of greater than 100 indicates that the composition offers better wet grip.

### III-2 Synthesis of the Copolymer E1

In the synthesis of polymers, all the reagents are obtained commercially except for the metallocenes. The butyloctylmagnesium BOMAG (20% in heptane, C=0.88 mol·l⁻¹) is obtained from Chemtura and is stored in a Schlenk tube under an inert atmosphere. The ethylene, of N35 grade, is obtained from Air Liquide and is used without prior purification.

The copolymer of ethylene and of 1,3-butadiene: elastomer E1 (in accordance with the invention) is synthesized according to the procedure described below.

To a reactor containing, at 80° C., methylcyclohexane, and also ethylene (Et) and butadiene (Bd) in the proportions indicated in Table 1, butyloctylmagnesium (BOMAG) is added to neutralize the impurities in the reactor, then the catalytic system is added (see Table 1). At this moment, the reaction temperature is regulated at 80° C. and the polymerization reaction starts. The polymerization reaction takes place at a constant pressure of 8 bar. The reactor is fed throughout the polymerization with ethylene and butadiene (Bd) in the proportions defined in Table 1. The polymerization reaction is stopped by cooling, degassing the reactor and adding ethanol. An antioxidant is added to the polymer solution. The copolymer is recovered by drying in a vacuum oven to constant weight. The catalytic system is a preformed catalytic system. It is prepared in methylcyclohexane from a metallocene, [Me₂SiFlu₂Nd(μ-BH₄)₂Li(THF)], a co-catalyst, butyloctylmagnesium (BOMAG), and a preformation monomer, 1,3-butadiene, in the contents indicated in Table 1. It is prepared according to a preparation method in accordance with paragraph II.1 of patent application WO 2017/093654 A1.

The microstructure of copolymer E1 and the properties thereof are shown in Tables 2 and 3. For the microstructure, Table 2 indicates the mole ratios of the ethylene (Eth) units, of the 1,3-butadiene units, and of the 1,2-cyclohexanediyl (ring) units.

TABLE 1

| Synthesis | E1 |
|---|---|
| Metallocene concentration (mmol/l) | 0.07 |
| Alkylating agent concentration (mmol/l) | 0.36 |
| Preformation monomer/Nd metal mole ratio | 90 |
| Feed composition (mol % Et/Bd) | 80/20 |

TABLE 2

| Elastomer | E1 |
|---|---|
| Ethylene (mol %) | 77 |
| 1,3-Butadiene (mol %) | 15 |
| 1,2-Cyclohexanediyl (mol %) | 8 |

TABLE 3

| Elastomer | E1 |
|---|---|
| Tg (° C.) | −40° C. |
| Mn (g/mol) | 128 888 |
| Mooney (ML (1 + 4)) at 100° C. | 60 |

### III-3 Preparation of the Compositions

In the examples that follow, the rubber compositions were produced as described in point II-6 above. In particular, the “non-productive” phase was performed in a 0.4 litre mixer for 3.5 minutes, at an average paddle speed of 50 rpm, until a maximum dropping temperature of 160° C. was reached. The “productive” phase was performed in an open mill at 23° C. for 5 minutes. The crosslinking of the composition was performed at a temperature of 150° C., under pressure, for a period of 60 minutes.

### III-4 Tests on Rubber Compositions

The objective of the examples presented below is to compare the rolling resistance and wet grip performance properties of a composition in accordance with the present invention (C1) with a control composition (T1). The compositions tested (in phr) and the results obtained are presented in Table 4.

The control composition T1 corresponds to a composition from the prior art. The composition C1 differs from the control composition T1 only in terms of the nature of the liquid plasticizer.

TABLE 4

| Compositions | T1 | C1 |
|---|---|---|
| Elastomer E1 (1) | 100 | 100 |
| Silica (2) | 96 | 96 |
| Coupling agent (3) | 8 | 8 |
| Carbon black (4) | 2 | 2 |
| Plasticizing resin (5) | 30 | 30 |
| Liquid plasticizer 1 (6) | 15 | — |
| Liquid plasticizer 2 (7) | — | 15 |
| DPG (8) | 2.1 | 2.1 |
| Ozone wax (9) | 2.5 | 2.5 |
| 6-PPD (10) | 3.5 | 3.5 |
| TMQ (11) | 1.5 | 1.5 |
| Stearic acid (12) | 3 | 3 |
| ZnO (13) | 1 | 1 |
| Vulcanization accelerator (14) | 2.5 | 2.5 |
| Sulfur | 1 | 1 |

Performance

| | | |
|---|---|---|
| Tan(δ)max at 23° C. | 100 | 116 |
| Int. tan(δ) [−30° C.; 0° C.] | 100 | 127 |

(1) Elastomer E1 prepared in point III-2 above
(2) Silica, Zeosil 1165MP from Solvay
(3) Triethoxysilylpropyl tetrasulfide (TESPT) liquid silane, Si69 from Evonik
(4) Carbon black of N234 grade according to the standard ASTM D-1765
(5) Escorez 5000 series resin from ExxonMobil (Tg = 52° C.)
(6) MES/HPD oil, Catenex SNR from Shell (Tg = −60° C.)
(7) Glycerol trioleate (sunflower oil comprising 85% by weight of oleic acid), Lubrirob Tod 1880 from Novance (Tg = −90° C.)
(8) Diphenylguanidine, Perkacit DPG from Flexsys
(9) Anti-ozone wax, Varazon 4959 from Sasol Wax
(10) N-(1,3-Dimethylbutyl)-N-phenyl-para-phenylenediamine, Santoflex 6-PPD from Flexsys
(11) 2,2,4-trimethyl-1,2-dihydroquinoline, Pilnox TMQ from Lanxess
(12) Stearic acid, Pristerene 4931 from Uniqema
(13) Zinc oxide of industrial grade from Umicore
(14) N-Cyclohexyl-2-benzothiazolesulfenamide, Santocure CBS from Flexsys

The results presented in Table 4 above show that replacing a conventional oil from the prior art with a specific liquid plasticizer comprising from 45% to 100% by weight of unsaturated fatty acid triester of glycerol in compositions based on a highly saturated diene elastomer makes it possible, surprisingly, to simultaneously improve two contradictory performances, namely rolling resistance and wet grip.

1.-15. (canceled)

16. A rubber composition based on at least:
an elastomer matrix comprising at least one copolymer containing ethylene units and 1,3-diene units, a molar fraction of ethylene units in the at least one copolymer being within a range extending from more than 50% to 95%, the at least one copolymer not containing any unit of a 1,3-diene of formula CH₂═CR—CH═CH₂, R representing a hydrocarbon chain having 3 to 20 carbon atoms;
a liquid plasticizer comprising from 45% to 100% by weight of unsaturated fatty acid triester of glycerol;
more than 30 phr of reinforcing filler; and
a crosslinking system.

17. The rubber composition according to claim 16, wherein the at least one copolymer containing ethylene units and 1,3-diene units is a copolymer of ethylene and of a 1,3-diene.

18. The rubber composition according to claim 16, wherein the 1,3-diene is 1,3-butadiene.

19. The rubber composition according to claim 16, wherein the at least one copolymer containing ethylene units and 1,3-diene units is a random copolymer.

20. The rubber composition according to claim 16, wherein a content of the at least one copolymer containing ethylene units and 1,3-diene units is within a range extending from 30 to 100 phr.

21. The rubber composition according to claim 16, wherein the fatty acid of the unsaturated fatty acid triester of glycerol comprises more than 60% by weight of a fatty acid selected from the group consisting of oleic acid, linoleic acid, linolenic acid and mixtures thereof.

22. The rubber composition according to claim 16, wherein the unsaturated fatty acid triester of glycerol is glycerol trioleate.

23. The rubber composition according to claim 16, wherein the unsaturated fatty acid triester of glycerol is a vegetable oil.

24. The rubber composition according to claim 16, wherein a content of the liquid plasticizer comprising from 45% to 100% by weight of unsaturated fatty acid triester of glycerol is within a range extending from 5 to 50 phr.

25. The rubber composition according to claim 16, wherein the reinforcing filler comprises more than 50% by weight of silica, the rubber composition additionally comprising at least one agent for coupling the silica to a diene elastomer.

26. The rubber composition according to claim 16, wherein a content of reinforcing filler is within a range extending from 35 to 200 phr.

27. The rubber composition according to claim 16, further comprising from 2 to 100 phr of plasticizing hydrocarbon resin having a glass transition temperature above 20° C.

28. The rubber composition according to claim 16, wherein the crosslinking system is a vulcanization system based on molecular sulfur and/or based on a sulfur-donating agent.

29. A rubber article comprising the rubber composition according to claim 16.

30. A pneumatic or non-pneumatic tire comprising the rubber composition according to claim 16.
